(19) United States
(12) Patent Application Publication
(10) Pub. No.: US 2005/0100413 A1
(43) Pub. Date: May 12, 2005

(54) Roto-erector for J-Lay pipelaying system

(76) Inventor: Benton F. Baugh, Houston, TX (US)

Correspondence Address: Benton F. Baugh, 14626 Oak Bend, Houston, TX, 77079, US

(21) Appl. No.: 10/678,282

(22) Filed: Oct. 6, 2003

(51) Int. Cl. F16L 1/036

(52) U.S. Cl. 405/184.5

(57) ABSTRACT

In the j-laying of a pipeline from an offshore floating vessel, the method for raising a pipe section from a horizontal position proximate the deck of the floating vessel to alignment with a mast for being connected to the end of the pipeline, comprising providing a main support arm which is pivoted from a horizontal position to a position parallel to the mast, providing a rotational axis mounted on the main support arm, providing grabbers mounted on the rotational axis to engage the pipe section on the deck, rotating the grabbers about the center of the rotational axis from a position below the rotational axis to a second position above the rotational axis, pivoting the main support arm and the pipe section to a position parallel to the mast, and delivering the pipe section to the mast.

### RELATED APPLICATIONS

None

### BACKGROUND OF THE INVENTION

1. Field of the Invention

This invention relates generally to laying underwater pipelines in relatively deep water using a J-Lay method from a floating vessel and, more particularly, to installing underwater pipelines on the seabed and/or connecting the same to floating terminals at the surface.

2. Description of the Related Art

Subsea pipelines have most often been laid on the ocean floor by connection of welding on the deck of a barge, lowering off the back of the barge down a stinger or curved guide, and then laying on the ocean floor. The curve down off the barge and then reverse curve onto the ocean floor gives an “S” bend in the pipeline during the lay process. The stinger allows the pipeline and its associated weight to be curved down toward the ocean floor without kinking or damaging the pipeline. As water depths become greater; the size, weight, and cost of the stinger become prohibitive.

In deeper water, it is advantageous to connect the pipeline near vertically and lower it directly into the water, with a single bend at the ocean floor. This gives the shape of a “J” for a system known as J-Laying pipe. The “J” cannot be vertical at the top, but rather must have an angle with a horizontal component to be able to pull horizontal tension on the pipeline as it is being laid onto the ocean floor. If it does not have horizontal tension, it will buckle as it is laid on the ocean floor and be damaged beyond use.

Sections of pipe are sequentially brought into the mast structure of a J-Lay system and welded to the end of the pipeline depending from the J-Lay system. As each section is welded in place, the pipeline is lowered by the length of the new pipe section and the vessel moves forward a similar amount. In most cases the vessel will move forward at a slow and continuous speed, whereas the pipeline itself is lowered in a stepwise fashion.

A common requirement for J-Lay systems such as this is to bring the new sections of pipe into the mast for welding. As the new pipe sections are normally stored horizontally, they must be erected to a near vertical position. An erector arm can be provided which will move the pipe about a pivot from horizontal to near vertical positioning. A crane or multiple jib cranes can be used to lift the pipe from the deck storage racks up to the gripping mechanisms on the top side of the erector arm.

A difficulty arises when the crane uses its cable to pick up a new pipe section it is sensitive to weather conditions. In still water it will not be difficult to move the new pipe section to the grippers on an erector. In marginal weather conditions, the motion of the vessel can cause a swinging motion of the new pipe section, making it difficult and potentially unsafe to try to land.

As the pipeline starts to swing, the operations become weather sensitive. It can cause the operations of the vessel to be shut down for safety of operating personnel, when productive operations could be carried on otherwise.

The present invention is directed to overcoming, or at least reducing the effects of, one or more of the problems set forth above.

### SUMMARY OF THE INVENTION

The object of this invention is to provide an erector for a J-Lay tower which will provide a positive control of the motion of the new pipe section at all times.

A second object of this invention is to provide means for controlling the position of the new pipe section in a way which will extend the weather window of operations.

Another object of this invention is to provide means to pick up a new section below an erector arm, move it above the erector, and present it to the mast.

Other objects and advantages of the invention will become apparent upon reading the following detailed description and upon referring to the drawings which follow.

### BRIEF DESCRIPTION OF THE DRAWINGS

FIG. 1 illustrates the apparatus for assembling and deploying pipe string underwater, mounted on the rear of a floating vessel and deploying a pipeline.

FIG. 2 shows a more detailed perspective view of the apparatus.

FIG. 3 illustrates the erector system of the embodiment in various angular positions.

FIG. 4 shows an end view of the erector of this invention with the grabber deployed below the erector engaging a new section of pipe.

FIG. 5 shows the grabber in the same angular position as is in figure no 4, with the grabber retracted toward the main erector arm.

FIG. 6 shows the erector rotated to the vertical position above the main erector arm.

FIG. 7 shows a side view of a portion of the erector showing the extension mechanism.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover ail modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

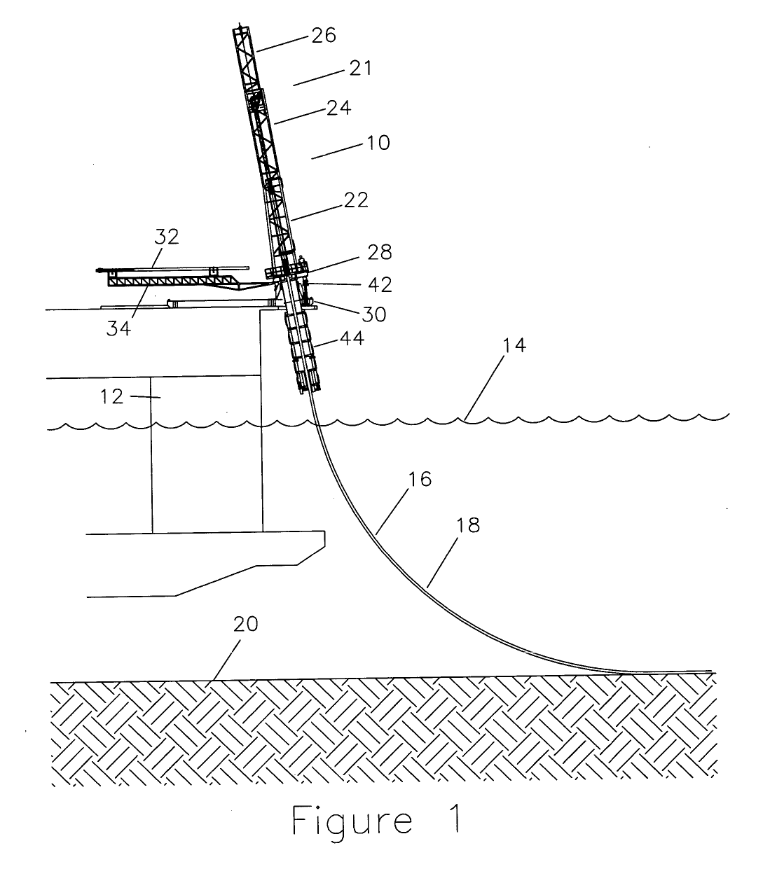

Referring now to FIG. 1, the j-lay tower 10 is shown on a floating vessel 12 in a body of water 14 with a pipeline 16 extending below the j-lay tower 10 around a bend 18 and onto the ocean floor 20. The j-lay tower 10 is shown with a mast 21 including a lower section 22, a middle section 24, and an upper section 26; a working table 28; and a skid 30. A new pipeline section 32 is shown on the erector 34. The erector can be pivoted up to the mast to deliver the pipe either by being pushed up by hydraulic cylinders or pulled up by a wire rope attached to the mast.

As can be noted, the tower is inclined at an angle convenient to the laying of the pipeline. Jack assemblies 42 assist in the changing of the tower angle as required. Stinger 44 provides internal rollers whose inner diameter provide a curvature to prevent overbending of the pipeline. The preferred running style is with the tower perfectly aligned to the pipeline, while using the angle gained around the curvature of the stinger as a margin of error if unforeseen events occur.

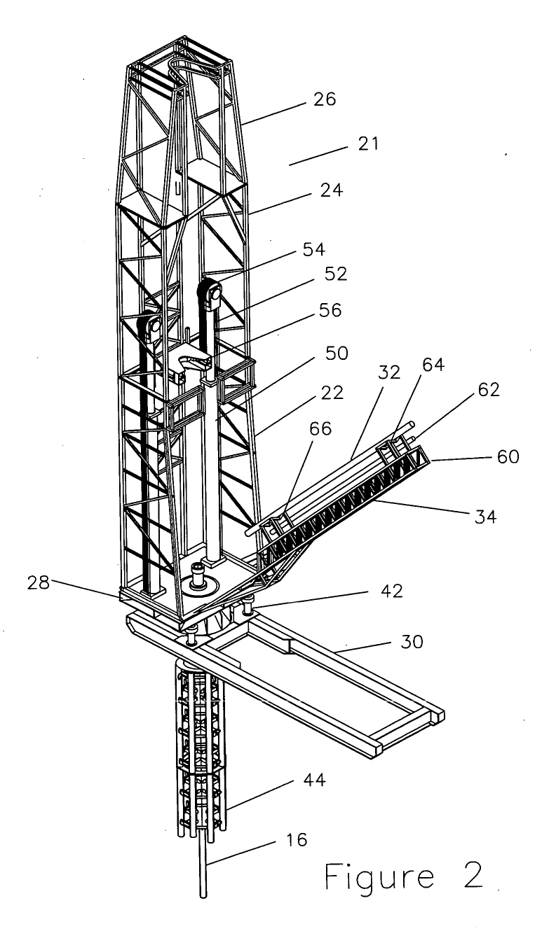

Referring now to FIG. 2, a perspective view of the apparatus is shown with the erector 34 shown partially raised toward the mast sections 22, 24, and 26. Main cylinders 50, with cables 52 over drums 54 are used to lift the travelling table 56 to power the system. Erector 34 is shown with main arm 60, pivot axle 62, and grabbers 64 and 66. Grabbers 64 and 66 are shown in a position above erector main arm 60. As will be seen later, grabbers 64 and 66 and be rotated about the pivot axle 62 to a position below main erector arm 60 for picking up pipe.

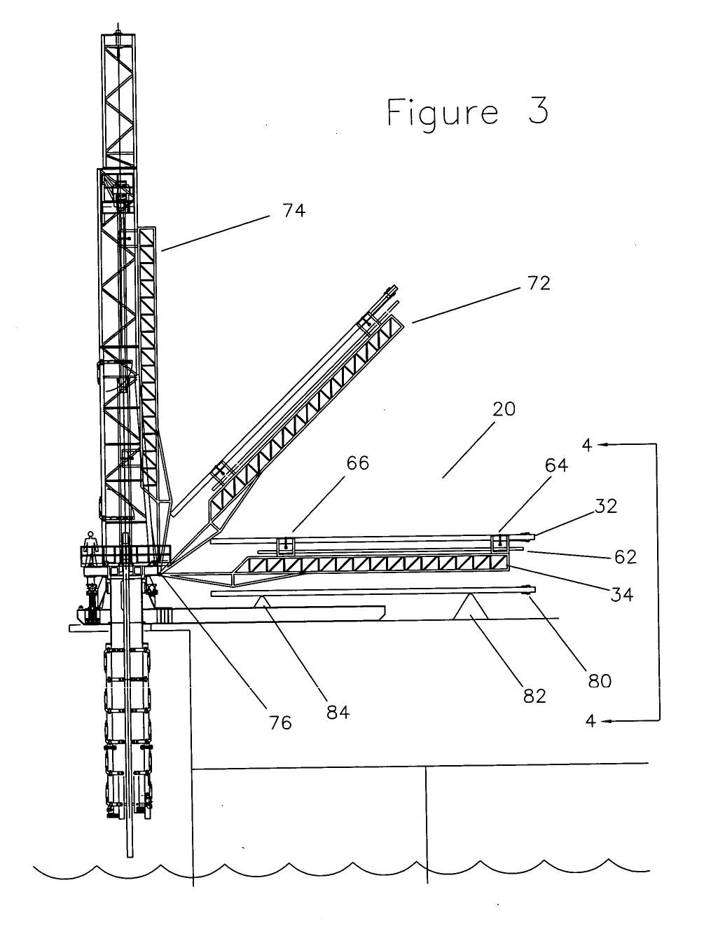

Referring now to FIG. 3, the erector 34 with new pipeline section 32 is shown in the horizontal position at 70, raised 45 degrees at 72, and engaging the vertical mast at 74. It is pivoted about axles at 76. An additional new pipe section 80 is shown on pipe racks 82 and 84 waiting on being picked up by grabbers 64 and 66 when the grabbers 64 and 66 are rotated down about the pivot axle 62.

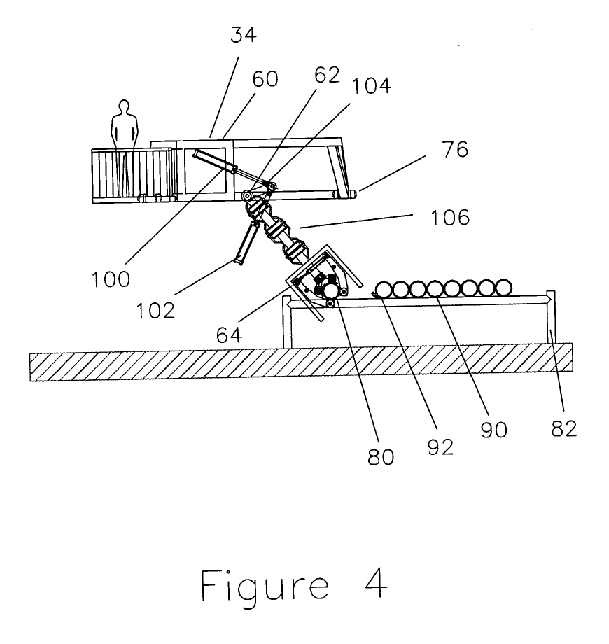

Referring now to FIG. 4, a partial view of FIG. 3 is shown taken along lines “4-4”. Grabber 64 is shown pivoted down about pivot axle 62 and engaging new pipe section 80. Additional new pipe sections are shown at 90, restrained by a stop arm at 92. Cylinders 100 and 102 provide the power to rotate the grabber by pushing on arm 104 which is attached to pivot axle 62. Scissor mechanism 106 is used to extend and retract the grabber 64, as will be described later.

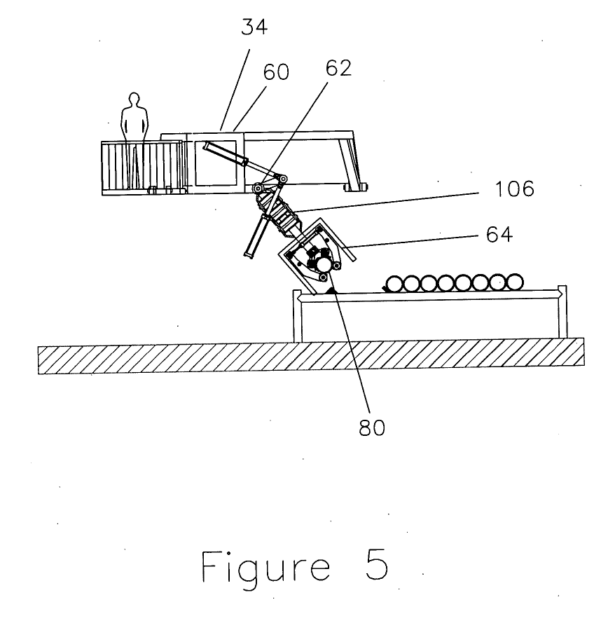

Referring now to FIG. 5, the scissor mechanism 106 has been retracted to allow the grabber to be rotated clockwise about pivot axle 62 to move new pipe section 80 above main erector arm 60.

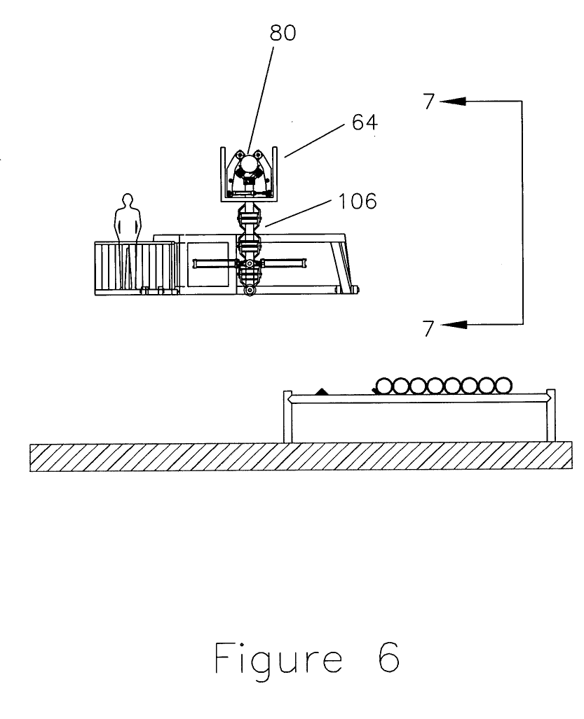

Referring now to FIG. 6, grabber has been rotated to the upper position, ready for engagement with the mast. In addition to being positioned for engagement with the mast, the scissor mechanism can be extended to give adjustment flexibility to the alignment of the new pipe section in the mast.

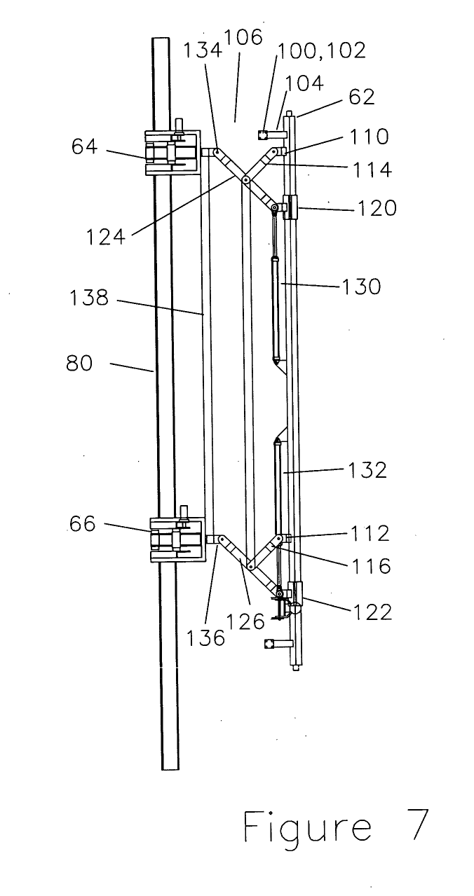

Referring now to FIG. 7, a partial view of FIG. 6 is shown which is taken along lines “7-7”. Brackets 110 and 112 are attached to pivot axle 62 with arms 114 and 116 attached. Collars 120 and 122 are slidably mounted around the pivot axle 62 with arms 124 and 126. Arms 124 and 126 are interconnected to arms 114 and 116. When cylinders 130 and 132 move collars 120 and 122 to the right or to the left, pinned connections 134 and 136 move vertically away from the pivot axle 62. Bar 138 interconnects grabbers 64 and 66 so that they remain in a fixed relative position. In this way a horizontal stroking of cylinders 130 and 132 provide for vertical extension and retraction of grabbers 64 and 66.

By this combination of extension and rotation, the grabbers can engage a new pipe section below the main erector arm, raise it to a position above the main erector arm and extend it into a position of matching the centerline of the mast after the erector has been appropriately raised.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. In the j-laying of a pipeline from an offshore floating vessel, the method for raising a pipe section from a horizontal position proximate the deck of said floating vessel to alignment with a mast for being connected to the end of the pipeline, comprising
providing a main support arm which is pivoted from proximately a horizontal position to a position proximately parallel to said mast,
providing a rotational axis mounted on said main support arm,
providing grabbers mounted on said rotational axis,
engaging said pipe section proximate said deck,
rotating said grabbers about the center of said rotational axis from a position below said rotational axis to a second position above said rotational axis,
pivoting said main support arm and said pipe section to a position proximately parallel to said mast, and
delivering said pipe section to said mast.

2. The method of claim 1, further comprising said grabbers are extended to first position to engage said pipe section proximate said deck.

3. The method of claim 2, further comprising said grabbers are retracted to a third position closer to said rotational axis than said first position prior to rotating said grabbers about said rotational axis to said second position.

4. The method of claim 3, further comprising providing a scissor type mechanism to move said pipe section from said second position to a fourth position for delivery to said mast.

5. The invention of claim 4, further comprising the use of force parallel to said rotational axis to extend and retract said scissor mechanism and said grabbers proximately perpendicular to said rotational axis.

6. The invention of claim 5, further providing the use of hydraulic cylinders to provide said force to extend and retract said scissor mechanism.

7. In the j-laying of a pipeline from an offshore floating vessel, the method for raising a pipe section from a horizontal position proximate the deck of said floating vessel to alignment with a mast for being connected to the end of the pipeline, comprising
providing a main support arm which is pivoted from proximately a horizontal position to a position proximately parallel to said mast,
providing a rotational axis mounted on said main support arm proximately perpendicular to said rotational axis,
providing grabbers mounted on said rotational axis,
extending said grabbers to a first position a first distance from said rotational axis to allow said grabbers to engage said pipe section proximate said deck,
rotating said grabbers about the center of said rotational axis from a position below said rotational axis to a second position above said rotational axis,
pivoting said main support arm and said pipe section to a position proximately parallel to said mast, and
delivering said pipe section to said mast.

8. The method of claim 7, further comprising the extending said grabbers from said second position to a fourth position for delivery of said pipe section to said mast.

9. The method of claim 8, further comprising said grabbers are extended from said second position to said fourth position by a scissors mechanism.

10. The invention of claim 9, further comprising the use of force parallel to said rotational axis to extend and retract said scissor mechanism.

11. The invention of claim 10, further providing the use of hydraulic cylinders to provide said force to extend and retract said scissor mechanism.

12. A method of raising a pipe section from the deck of an floating vessel to a mast for welding onto the end of a pipeline suspended from said floating vessel for deploying said pipe section and the welded pipeline into the water as a pipeline, comprising
providing a main support arm with a pivot axis proximate one end of said main support arm,
providing a rotational axis along said main support arm proximately perpendicular to said pivot,
mounting one or more grabbers on said rotational axis to engage said pipeline section proximate said deck when said grabbers are in a first position,
rotating said one or more grabbers to a second position relative to said main support arm,
pivoting said main support arm from a generally horizontal angle to a generally vertical angle, and
delivering said pipe section to said mast.

13. The method of claim 12, further comprising moving said grabbers to a third position closer to said rotational axis prior to rotating said one or more grabbers to said second position.

14. The method of claim 13, further comprising providing a scissor type mechanism to move said pipe section from said first position to said third position.

15. The method of claim 12, further comprising extending said grabbers to a fourth position further from said rotational axis than said second position while delivering said pipe section to said mast.

16. The method of claim 15, further comprising providing a scissor type mechanism to move said pipe section from said second position to said fourth position.

17. The invention of claim 16, further comprising the use of force parallel to said rotational axis to extend and retract said scissor mechanism.

18. The invention of claim 17, further providing the use of hydraulic cylinders to 11 provide said force to extend and retract said scissor mechanism.

19. The method of claim 12, further comprising the interconnecting of said main support arm to the base of said mast.

20. The method of claim 12, further comprising said mast is gimbaled relative to said floating vessel.

21. The method of claim 20, further comprising gimballing said interconnection of said main support arm when said mast is gimbaled.
